(19) United States
(12) Patent Application Publication
(10) Pub. No.: US 2015/0147582 A1
(43) Pub. Date: May 28, 2015

(54) Enhanced-Rigidity Magnetic Sheet Systems

(71) Applicant: Jerry L. King, Williamstown, WV (US)

(72) Inventor: Jerry L. King, Williamstown, WV (US)

(73) Assignee: MAGNUM MAGNETICS CORPORATION, Marietta, OH (US)

(21) Appl. No.: 13/459,011

(22) Filed: Apr. 27, 2012

Related U.S. Application Data
(63) Continuation-in-part of application No. 12/748,123, filed on Mar. 26, 2010, now abandoned.
(60) Provisional application No. 61/164,258, filed on Mar. 27, 2009.
(60) Provisional application No. 61/260,337, filed on Nov. 11, 2009.
(60) Provisional application No. 61/259,528, filed on Nov. 9, 2009.
(60) Provisional application No. 61/511,419, filed on Jul. 25, 2011.
(60) Provisional application No. 61/501,711, filed on Jun. 27, 2011.
(60) Provisional application No. 61/479,469, filed on Apr. 27, 2011.

(51) Int. Cl. H01F 1/00; H01F 1/37; C08K 3/22; H01F 1/117; C09D 133/06

(52) U.S. Cl. CPC H01F 1/37
USPC 428/480; 252/62.54; 252/62.51 R; 252/62.53; 524/563; 252/62.54

(57) ABSTRACT

A system relating to providing printable/writable magnetic sheets comprising a favorable balance of mechanical rigidity and flexibility for improved handling during processing steps required for the manufacture of such printable/writable magnetic sheets.

### CROSS REFERENCE TO RELATED APPLICATION

The present application is a continuation-in-part and is related to and claims priority from application Ser. No. 12/748,123, filed Mar. 26, 2010, entitled “REDUCED ENVIRONMENTAL-IMPACT MAGNETIC SYSTEMS”; and, which application is related to and claims priority from prior provisional application Ser. No. 61/164,258, filed Mar. 27, 2009, entitled “REDUCED ENVIRONMENTAL-IMPACT MAGNETIC SYSTEMS”; and, which application is related to and claims priority from prior provisional application Ser. No. 61/260,337, filed Nov. 11, 2009, entitled “REDUCED ENVIRONMENTAL-IMPACT MAGNETIC SYSTEMS”; and, which application is related to and claims priority from prior provisional application Ser. No. 61/259,528, filed Nov. 9, 2009, entitled “MAGNETIC SHEET RECYCLING SYSTEMS”; the contents of all of which are incorporated herein by this reference and are not admitted to be prior art with respect to the present invention by the mention in this cross-reference section.

Furthermore, the present application is related to and claims priority from prior provisional application Ser. No. 61/511,419, filed Jul. 25, 2011, entitled “ENHANCED-RIGIDITY MAGNETIC SHEET AND PRINTABLE COATING SYSTEMS”; and, this application is related to and claims priority from prior provisional application Ser. No. 61/501,711, filed Jun. 27, 2011, entitled “ENHANCED-RIGIDITY MAGNETIC SHEET SYSTEMS”; and, this application is related to and claims priority from prior provisional application Ser. No. 61/479,469, filed Apr. 27, 2011, entitled “ENHANCED RIGIDITY MAGNETIC SHEET SYSTEMS”; the contents of all of which are incorporated herein by this reference and are not admitted to be prior art with respect to the present invention by the mention in this cross-reference section.

### BACKGROUND

This invention relates to providing a system for improved control of mechanical flexibility in magnetic sheets and the development of printable coatings for such sheets. More particularly, this invention relates to providing coated magnetic sheets with controlled mechanical flexibility and rigidity for improved handling during printing and other manufacture processes. Magnetic sheets comprising laminated coatings derive increased mechanical rigidity by interactions with the laminate. In contrast, thin, fluid-applied coatings contribute minimal mechanical rigidity to the magnetic sheet products to which they are applied. Inadequate mechanical rigidity frequently leads to poor handling during processes (printing, cutting, tipping, inserting, etc.) required for the manufacture of printable/writable magnetic sheet products employing such thin, fluid-applied coatings. Hence, there is a need to enhance the mechanical rigidity of magnetic sheets employing such thin, writable coatings.

### OBJECTS AND FEATURES OF THE INVENTION

A primary object and feature of the present invention is to provide a system overcoming the above-mentioned problem.

It is a further object and feature of the present invention to provide such a system for providing magnetic sheets with enhanced mechanical rigidity. It is a further object and feature of the present invention to provide such a system for providing magnetic sheets comprising a favorable balance of rigidity and flexibility for improved handling with commercial printers, cutting tools, and other processing equipment required for the manufacture of such magnetic sheets.

Another object and feature of the present invention is to provide a set of chemical formulations for magnetic sheets which provide such a favorable balance of rigidity and flexibility to such magnetic sheets. Another object and feature of the present invention is to provide such a set of chemical formulations for magnetic sheets comprising a surfactant. Yet another object and feature of the present invention is to provide such a set of chemical formulations for magnetic sheets comprising at least one stiff binder to provide stiffening properties to such magnetic sheets.

Yet another object and feature of the present invention is to provide a set of chemical formulations for magnetic sheets employing a surfactant to mediate the interaction between at least one stiff binder and a magnetizable material present in such magnetic sheets. Yet another object and feature of the present invention is to provide a set of chemical formulations for magnetic sheets employing a surfactant to enhance the loading-capacity for a magnetizable material in such magnetic sheets. Yet another object and feature of the present invention is to provide a set of chemical formulations for magnetic sheets employing at least one surfactant to enhance the loading-capacity for stiff binders in such magnetic sheets.

Another object and feature of the present invention is to provide a set of chemical formulations for magnetic sheets comprising a flexible binder to provide flexibility to such magnetic sheets. Yet another object and feature of the present invention is to provide a set of chemical formulations for magnetic sheets comprising an elastomeric binder to provide elastomeric properties to such magnetic sheets. Another object and feature of the present invention is to provide a set of chemical formulations for magnetic sheets which provide enhanced tear resistance.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a system, relating to providing at least one magnetic sheet, comprising: at least one magnetizable sheet structured and arranged to provide at least one permanent magnetic field upon magnetization by at least one magnetic-field source; wherein such at least one magnetizable sheet comprises at least one magnetizable-material structured and arranged to be magnetized by such at least one magnetic-field source; wherein such at least one magnetizable sheet further comprises at least one binder structured and arranged to bind such at least one magnetizable-material in such at least one magnetizable sheet; wherein such at least one magnetizable sheet further comprises at least one interfacial-tension-reducer structured and arranged to reduce the interfacial tension between such at least one magnetizable-material and such at least one binder; wherein such at least one binder comprises at least one first stiffener structured and arranged to stiffen such at least one magnetizable sheet; wherein such at least one magnetizable sheet provides a favorable balance of stiffness and flexibility for enhancing the handling of such at least one magnetizable sheet with commercial printers, cutting tools, and processing equipment required for the manufacture of such at least one magnetizable sheet.

Moreover, it provides such a system wherein such at least one interfacial-tension-reducer comprises at least one magnetizable-material-loading-capacity-enhancer structured and arranged to enhance the capacity for loading such at least one magnetizable-material in such at least one magnetizable sheet. Additionally, it provides such a system wherein such at least one interfacial-tension-reducer further comprises at least one binder-capacity-loading-enhancer structured and arranged to enhance the capacity for loading of such at least one binder in such at least one magnetizable sheet. Also, it provides such a system wherein such at least one interfacial-tension-reducer further comprises at least one disperser structured and arranged to disperse such at least one magnetizable-material in such at least one magnetizable sheet. In addition, it provides such a system wherein such at least one interfacial-tension-reducer comprises at least one elongation-enhancer structured and arranged to enhance the ability to elongate such at least one magnetizable sheet. In addition, it provides such a system wherein such at least one interfacial-tension-reducer comprises at least one tear-resistance-enhancer structured and arranged to enhance the ability of said at least one magnetizable sheet to resist tearing. And, it provides such a system wherein such at least one interfacial-tension-reducer comprises at least one polyester resin derived from soy. Further, it provides such a system wherein such at least one interfacial-tension-reducer is selected from the group consisting of at least one polyester resin derived from soy, stearic acid, calcium stearate, at least one abeitic acid ester, at least one rosin ester, at least one terpene phenolic ester, at least one styrene-acrylate copolymer, and at least one acrylate copolymer resin.

Even further, it provides such a system wherein such at least one magnetizable sheet further comprises: at least one indicia-acceptor structured and arranged to accept at least one indicia on at least one surface of such at least one magnetizable sheet; wherein such at least one indicia-acceptor is applied to such at least one surface of such at least one magnetizable sheet. Moreover, it provides such a system wherein such at least one polyester resin is present from about one-tenth of a percent to about ten percent, by weight, in such at least one magnetizable sheet. Additionally, it provides such a system wherein such at least one interfacial-tension-reducer is present from about one-tenth of a percent to about ten percent, by weight, in such at least one magnetizable sheet. Also, it provides such a system wherein such at least one interfacial-tension-reducer further comprises at least one adhesion-promoter structured and arranged to promote the adhesion of such at least one indicia-acceptor to such at least one surface of such at least one magnetizable sheet.

In addition, it provides such a system wherein such at least one first stiffener is selected from the group consisting of low-density polyethylene, linear low-density polyethylene, and at least one mixture of such low-density polyethylene and such linear low-density polyethylene. And, it provides such a system wherein such at least one first stiffener is present from about ten percent to about forty percent, by weight, in such at least one magnetizable sheet. Further, it provides such a system wherein such at least one first stiffener is obtained from post-manufacture plastic bag waste. Even further, it provides such a system wherein such at least one binder further comprises at least one second stiffener structured and arranged to stiffen such at least one magnetizable sheet.

Moreover, it provides such a system wherein such at least one second stiffener comprises at least one ethylene vinyl acetate copolymer. Additionally, it provides such a system wherein such at least one ethylene vinyl acetate copolymer is present from about twelve to about twenty-two percent, by weight, in such at least one magnetizable sheet. Also, it provides such a system wherein such at least one binder further comprises at least one elastomeric-binder structured and arranged to provide elastomeric properties to such at least one magnetizable sheet. In addition, it provides such a system wherein such at least one elastomeric-binder is selected from the group consisting of at least one ethylene-octene copolymer, and least one propylene-based elastomer, and at least one mixture of such at least one ethylene-octene copolymer and such at least one propylene-based elastomer. And, it provides such a system wherein such at least one elastomeric binder is present from about eight percent to about thirty percent, by weight, in such at least one magnetizable sheet.

Further, it provides such a system wherein such at least one binder further comprises at least one flexible-binder structured and arranged to provide flexibility to such at least one magnetizable sheet. Even further, it provides such a system wherein such at least one flexible-binder comprises at least one chlorinated polyethylene elastomer. Even further, it provides such a system wherein such at least one chlorinated polyethylene elastomer is present at about forty percent, by weight, in such at least one magnetizable sheet. Even further, it provides such a system wherein such at least one magnetizable-material comprises at least one ferrite powder selected from the group consisting of strontium ferrite and barium ferrite.

In accordance with another preferred embodiment hereof, this invention provides a system, relating to providing at least one magnetic sheet, comprising: at least one magnetizable sheet structured and arranged to provide at least one permanent magnetic field upon magnetization by at least one magnetic-field source; wherein such at least one magnetizable sheet comprises at least one magnetizable-material structured and arranged to be magnetized by such at least one magnetic-field source; wherein such at least one magnetizable sheet further comprises at least one binder structured and arranged to bind such at least one magnetizable-material in such at least one magnetizable sheet; wherein such at least one magnetizable sheet further comprises at least one interfacial-tension-reducer structured and arranged to reduce the interfacial tension between such at least one magnetizable-material and such at least one binder; wherein such at least one binder comprises at least one first-stiffener structured and arranged to stiffen such at least one magnetizable sheet; wherein such at least one interfacial-tension-reducer comprises at least one magnetizable-material-loading-enhancer structured and arranged to enhance the loading of such at least one magnetizable-material in such at least one magnetizable sheet; wherein such at least one interfactial-tension-reducer further comprises at least one binder-loading-enhancer structured and arranged to enhance the loading of such at least one binder in such at least one magnetizable sheet; wherein such at least one interfacial-tension-reducer comprises at least one polyester resin derived from soy; wherein such at least one first-stiffener is selected from the group consisting of low-density polyethylene, linear low-density polyethylene, and at least one mixture of such low-density polyethylene and such linear low-density polyethylene; wherein such at least one first-stiffener is obtained from post-manufacture plastic bag waste; wherein such at least one binder further comprises at least one second stiffener structured and arranged to stiffen such at least one magnetizable sheet; wherein such at least one second stiffener comprises at least one ethylene vinyl acetate copolymer; wherein such at least one binder further comprises at least one elastomeric-binder structured and arranged to provide elastomeric properties to such at least one magnetizable sheet; wherein such at least one elastomeric-binder is selected from the group consisting of at least one ethylene-octene copolymer, and least one propylene-based elastomer, and at least one mixture of such at least one ethylene-octene copolymer and such at least one propylene-based elastomer; wherein such at least one binder further comprises at least one flexible-binder structured and arranged to provide flexibility to such at least one magnetizable sheet; wherein such at least one flexible-binder comprises at least one chlorinated polyethylene elastomer; wherein such at least one magnetizable-material comprises at least one ferrite powder selected from the group consisting of strontium ferrite and barium ferrite; and wherein such at least one magnetizable sheet provides a favorable balance of stiffness and flexibility for enhancing the handling of such at least one magnetizable sheet with commercial printers, cutting tools, and processing equipment required for the manufacture of such at least one magnetizable sheet.

In accordance with another preferred embodiment hereof, this invention provides a system, relating to providing at least one magnetic sheet, comprising: magnetizable-sheet means for providing at least one permanent magnetic field upon magnetization by at least one magnetic-field source; wherein such magnetizable-sheet means comprises magnetizable-material means for being magnetized by such at least one magnetic-field source; wherein such magnetizable-sheet means comprises binder means for binding such magnetizable-material means in such magnetizable-sheet means; wherein such magnetizable-sheet means comprises interfacial-tension-reducer means for reducing the interfacial tension between such magnetizable-material means and such binder means; wherein such binder means comprises first-stiffener means for stiffening such magnetizable-sheet means; wherein such magnetizable-sheet means provides a favorable balance of stiffness and flexibility for enhancing the handling of such at least one magnetizable sheet with commercial printers, cutting tools, and processing equipment required for the manufacture of such at least one magnetizable sheet.

In accordance with another preferred embodiment hereof, this invention provides a system, relating to providing at least one magnetic sheet, comprising: at least one magnetizable sheet structured and arranged to provide at least one magnetic field upon magnetization by at least one magnetic field source, comprising at least one magnetizable material selected from the group consisting of barium ferrite and strontium ferrite, from about one-tenth of a percent to about ten percent, by weight, of at least one surfactant selected from the group consisting of at least one polyester resin derived from soy, stearic acid, calcium stearate, at least one abeitic acid ester, at least one rosin ester, at least one terpene phenolic ester, at least one styrene-acrylate copolymer, and at least one acrylate copolymer, from about ten percent to about forty percent, by weight, of at least one first stiff binder selected from the group consisting of low-density polyethylene, linear low-density polyethylene, and at least one mixture of such low-density polyethylene and such linear low-density polyethylene, from about twelve percent to about twenty-two percent, by weight, of at least one ethylene vinyl acetate copolymer, about forty percent, by weight, of chlorinated polyethylene elastomer; from about eight percent to about thirty percent, by weight, of at least one elastomeric binder selected from the group consisting of at least one low-density ethylene-octene copolymer, at least one low-density propylene elastomer, and at least one mixture of such at least one low-density ethylene-octene copolymer and such at least one low-density propylene elastomer, and wherein such at least one magnetizable sheet provides a favorable balance of stiffness and flexibility for enhancing the handling of such at least one magnetizable sheet with commercial printers, cutting tools, and processing equipment required for the manufacture of such at least one magnetizable sheet.

In addition, this invention provides every novel feature, element, combination, step and/or method suggested by this patent application.

### GLOSSARY

The following physical properties, physical parameters, and measurements are explained below as background and are used throughout the detailed description.

Rigidity: the quality or state of being stiff and low in flexibility. In the detailed description, the term rigidity is used interchangeably with the term stiffness.

Stiffness: the quality or state of being rigid or firm or not easily bent. In the detailed description, the term stiffness is used interchangeably with the term rigidity.

Elastic: capable of being easily stretched and resuming former shape.

Fold test: measures the ability of a sample to bend before breakage occurs.

Tensile strength: the force required to pull a sample to the point of breakage, expressed in pounds per square inch (psi) in the detailed description.

Tensile elongation: the maximum tensile stress which can be sustained by a sample before breaking.

Tensile stress: the stress applied to a sample which leads to sample expansion.

Yield strength (yield point): the tensile stress applied to a sample which causes noticeable and significant deformation in the sample, expressed in pounds per square inch (psi) in the detailed description.

Tear strength: the resistance of a sample to tear.

Toughness: the ability of a sample to absorb energy and deform plastically before fracture.

Break stress: the tensile stress applied to a sample at which breakage occurs.

Shore durometer: instrument or measurement which measures a sample's hardness or resistance to permanent indentation.

Shore durometer hardness: the hardness of a sample determined by a shore durometer measurement.

Elongation at break: the percentage elongation of a sample before breaking, expressed as a percentage of the original length.

Elongation at yield: the percentage elongation of a sample at the moment the tensile yield strength of the sample is attained.

Modulus of Rigidity: a measure of the stiffness of a material in a torsion test. This characteristic reflects the change of strain as a function of applied shear or torsion stress. The modulus of rigidity of a sample can be measured by the ratio of tensile yield strength to elongation at yield, expressed in pounds per square inch (psi) in the detailed description.

Peel Adhesion: the force required to peel a laminated coating adhesively applied to the surface of a sample, expressed in ounces per inch (oz/in) in the detailed description.

Viscosity: a property which describes a fluid's resistance to flow.

Millage: the thickness of a sample expressed in mils.

Residual induction (Bᵣ): the magnetic induction remaining in a saturated magnetizable material after the magnetizing field has been removed, expressed in Gauss (G) in the detailed description.

Coercive force (H_{c}): the demagnetizing force required to reduce observed magnetic induction of a magnetizable material to zero after the magnetizable material has been brought to saturation, expressed in Oersteds (Oe) in the detailed description.

Intrinsic Coercive Force (H_{ci}): indicates the resistance of a magnetizable material to demagnetization. It is equal to the demagnetizing force which reduces the intrinsic induction (contribution of the magnetizable material to the total magnetic induction) in the material to zero after the magnet has been brought to saturation, expressed in Oersteds (Oe) in the detailed description.

Maximum energy product (BHmax): the magnetic field strength at the point of maximum energy product of a magnetizable material, expressed in Mega Gauss Oersteds (MGOe) in the detailed description.

### BRIEF DESCRIPTION OF THE DRAWINGS

FIG. 1 shows a perspective view, illustrating a controlled-flexibility magnetic sheet of controlled-flexibility magnetic sheet systems, according to the preferred embodiment of the present invention.

FIG. 2 shows a sectional view, through the section 2-2 of FIG. 1, according to the preferred embodiment of FIG. 1.

FIG. 3 shows a diagrammatic view, depicting preferred components of a magnetizable layer of the rigid magnetic sheet, according to the preferred embodiment of FIG. 1.

FIG. 4 shows a data graph, illustrating the increase in modulus of rigidity and tensile strength in magnetic sheets prepared with increasing weight percentages of first stiff binder.

### DETAILED DESCRIPTION OF THE BEST MODES AND PREFERRED EMBODIMENTS OF THE INVENTION

FIG. 1 shows controlled-flexibility magnetic sheet 102 of controlled-flexibility magnetic sheet systems 100, according to the preferred embodiment of the present invention. FIG. 2 shows a sectional view, through the section 2-2 of FIG. 1, according to the preferred embodiment of FIG. 1. Controlled-flexibility magnetic sheet 102 (at least embodying herein at least one magnetizable sheet structured and arranged to provide at least one permanent magnetic field upon magnetization by at least one magnetic-field source; and, at least embodying herein magnetizable-sheet means for providing at least one permanent magnetic field upon magnetization by at least one magnetic-field source) preferably comprises a preferred balance of rigidity and flexibility providing for improved handling during manufacture processes (see below). Controlled-flexibility magnetic sheet 102 preferably comprises at least one magnetizable layer 110, as shown. Magnetizable layer 110 preferably is comprised of at least one of a set of preferred chemical formulations which preferably provide a preferred balance of rigidity and flexibility to controlled-flexibility magnetic sheet 102 (see further details below).

Controlled-flexibility magnetic sheet 102 preferably may further comprise at least one indicia-accepting coating 104 (at least embodying herein at least one indicia-acceptor structured and arranged to accept at least one indicia on at least one surface of such at least one magnetizable sheet), as shown. Indicia-accepting coating 104 preferably is compatible with one or more printing processes, enabling controlled-flexibility magnetic sheet 102 to be directly printed upon in order to display desired text and/or images. Indicia-accepting coating 104 preferably comprises a thin fluid-applied, sprayed-on, or hot-melt coating (in each case preferably non-laminated) applied to at least one surface of magnetizable layer 110, as shown (this arrangement at least herein embodying wherein such at least one indicia-acceptor is applied to such at least one surface of such at least one magnetizable sheet).

Preferred indicia-accepting coatings 104 contribute minimally to the overall mechanical strength and rigidity of the final controlled-flexibility sheets 102. Upon reading this specification, those with ordinary skill in the art will now appreciate that, under appropriate circumstances, considering such issues as design preference, manufacturer preference, cost, changing needs, future technologies, etc., other types of coatings such as, for example, laminated coatings, adhesively-applied coatings, non-indicia-accepting coatings, plastic coatings, paper coatings, etc., may suffice.

Preferred indicia-accepting coating 104 include the following characteristics:
1) preferably produces a substantially white printable surface;
2) preferably are offset printable and have the ability to be coated or receptive to standard commercial ink lines (such as, for example, HP Indigo, Kodak Nexpress and Xerox Igen ink products).
3) must have an opacity, whiteness & gloss similar to or better than standard laminated papers with a minimum opacity range of about 93 percent, a brightness range of between about 88 percent and about 91 percent, and a gloss range of between about 70 percent and about 72 percent;
4) must preferably lay flat when exposed to temperature and humidity extremes;
5) must preferably not discolor (yellow) when exposed to Ultraviolet (UV) light under typical indoor applications;
6) must preferably provide a clean when cut with a guillotine-type shear or steel rule die;
7) must resist scuffing and abrasion;
8) must not delaminate when exposed to normal processing, handling, freight, and end use conditions;
9) must work with magnetizable layers 110 having a variety of thicknesses; and
10) must preferably possess a material safety rating essentially equivalent to conventional laminated materials (such as, low chemical toxicity low heavy metal content, etc.)

Preferred water-based coatings suitable for use as indicia-accepting coating 104 include flexo-graphically applied opaque white water-based inks number PIPW1619 from Printing Ink Partners of Middletown, Ohio, preferably applied using two passes with a 100-line anilox roll (LAB value equaling about 89).

Preferred UV-cured coatings suitable for use as indicia-accepting coating 104 include flexo-graphically-applied opaque white ink from Flint Group North America (LAB value equals about 89).

Applicant also developed a preferred proprietary Ethylene-Vinyl-Acetate-based (EVA-based) thermoplastic coating (also referred to herein as applicant's hot-melt coating) suitable for use as indicia-accepting coating 104 the preferred composition of this preferred coating is noted in the following formula (percentages by weight):

1) About 91.5 percent Escorene™ Ultra AD 2528 (EVA);

2) about 8 percent Titanium Dioxide; and

3) about 0.5 percent at least one chemical surfactant.

The above components of applicant's hot-melt coating are preferably melt mixed together using a material mixer. Then, the compound is preferably placed in a hot melt tank, melted, and applied onto magnetizable layer 110 with either a slot-die coater or roll coater. The chemical surfactant preferably comprises at least one biologically-derived polyester resin, preferably at least one polyester resin derived from soy, preferably at least one polyester resin derived from soy sold under the trademark BIOREZ™ (57-133-C or other grades) preferably supplied from Advanced Image Resources, LLC located in Alpharetta, Ga. Upon reading this specification, those with ordinary skill in the art will now appreciate that, under appropriate circumstances, considering such issues as design preference, manufacturer preference, cost, changing needs, future technologies, etc., other composition arrangements such as, for example, alternate percentages of materials, multiple surfactants, etc., may suffice.

Magnetizable layer 110 preferably comprises at least one of a set of preferred chemical formulations (see below) which preferably provide a combination of a preferred degree of stiffness and a preferred degree of flexibility, leading to improvements in the processing and manufacture of controlled-flexibility sheets 102. The above described favorable physical properties of controlled-flexibility magnetic sheets 102 have been at least partially attributed to the presence of at least one surfactant 125 (see FIG. 3) in magnetizable layer 110 (see additional details below).

Applicant has noted that previous flexible magnetic sheet systems employing such indicia-accepting coatings 104 often exhibit inadequate mechanical stiffness leading to poor handling during processing steps such as printing and sheet cutting. Controlled-flexibility magnetic sheets 102 preferably exhibit a preferred degree of rigidity leading to improved ease of handling with commercial printers and other processing equipment, such as cutting tools and extruding devices (see further details below). The preferred degree of rigidity of controlled-flexibility magnetic sheets 102 preferably provides improved register during printing. In addition, controlled-flexibility magnetic sheets 102 preferably provide a preferred degree of stiffness allowing for both improved ease of cutting and for improved ease of feeding into processing equipment. Furthermore, controlled-flexibility magnetic sheets 102 preferably comprise a favorable degree of flexibility preferably allowing controlled-flexibility magnetic sheets 102 to be rolled (see FIG. 1), to be elongated and/or bended to a preferred degree without breaking, and to be readily applied to curved surfaces in use.

FIG. 3 shows a diagrammatic view, depicting preferred components of magnetizable layer 110 of controlled-flexibility magnetic sheet 102, according to the preferred embodiment of FIG. 1. Fig.3 is shown for illustrative purposes only, and does not reflect relative concentrations or weight percentages, sizes, actual chemical structures, or actual interactions between components of magnetizable layer 110.

Through experimentation, applicant has discovered a set of preferred chemical formulations (depicted diagrammatically in FIG. 3) for magnetizable layer 110 which lend favorable properties for subsequent printing and processing steps associated with the manufacture of controlled-flexibility magnetic sheets 102. Magnetizable layer 110 preferably comprises magnetizable material 115, as shown. Magnetizable material 115 (at least herein embodying wherein such at least one magnetizable sheet comprises at least one magnetizable-material structured and arranged to be magnetized by such at least one magnetic-field source; and, at least herein embodying wherein such magnetizable-sheet means comprises magnetizable-material means for being magnetized by such at least one magnetic-field source) preferably is capable of providing a permanent magnetic field to controlled-flexibility magnetic sheet 102 upon magnetization by a magnetic field.

In magnetizable layer 110, magnetizable material 115 preferably is suspended in at least one polymeric matrix 122, as shown. Polymeric matrix 122 preferably comprises at least one polymeric binder 130, preferably at least one plurality of polymeric binders 130, as shown. Polymeric binders 130 (at least herein embodying wherein such at least one magnetizable sheet further comprises at least one binder structured and arranged to bind such at least one magnetizable-material in such at least one magnetizable sheet; and, at least herein embodying wherein such magnetizable-sheet means comprises binder means for binding such magnetizable-material means in such magnetizable-sheet means) preferably are structured and arranged to bind magnetizable material 115 into magnetizable layer 110, as shown. Furthermore, each polymeric binder 130 in magnetizable layer 110 preferably contributes at least one or more favorable physical properties to controlled-flexibility magnetic sheet 102 (see further details below).

Polymeric binders 130 preferably comprise at least one stiff binder 132, as shown. Stiff binder 132 preferably comprises at least one polymer with crystalline properties which provides increased stiffness to controlled-flexibility magnetic sheets 102. Stiff binder 132 preferably comprises at least one first stiff binder 135 and at least one second stiff binder 137, as shown. Polymeric binders 130 preferably further comprise at least one flexible binder 140 and at least one elastomeric binder 145, as shown. Polymeric matrix 122 preferably further comprises at least one surfactant 125, as shown. Many of the favorable properties reported for controlled-flexibility magnetic sheets 102 have been attributed to the presence of surfactant 125 in magnetizable layer 110 (see further details below). Upon reading this specification, those with ordinary skill in the art will now appreciate that, under appropriate circumstances, considering such issues as design preference, manufacturer preference, cost, changing needs, future technologies, etc., other types of composition arrangements such as, for example, non-polymeric binders, multiple surfactants, etc., may suffice.

Applicant has noted that the discovered chemical formulations lead to better die cutting and guillotine cut performance in resulting controlled-flexibility magnetic sheets 102. Applicant has further noted extended blade lives for cutting tools due to improved cutting ease of controlled-flexibility magnetic sheets 102. Applicant has further noted an extension in the lifetime of processing equipment when working with controlled-flexibility magnetic sheets 102 comprising the preferred chemical formulations. Furthermore, applicant has noted that the discovered chemical formulations allow for faster mixing, milling, and extrusion during the manufacture of controlled-flexibility magnetic sheets 102. Furthermore, applicant has noted the discovered chemical formulations allow for mixing, milling, and extrusion at a lower temperature and pressure and/or applied torque during the manufacture of controlled-flexibility magnetic sheets 102. Applicant has further noted an overall decrease in energy use for the production of controlled-flexibility magnetic sheets 102 due to such improved ease of processing. Applicant has further noted an improvement in the overall appearance of controlled-flexibility magnetic sheets 102 (less streakiness) comprising the preferred set of chemical formulations. In addition, applicant has noted better processing of thin sheets (around twelve mil in thickness) of controlled-flexibility magnetic sheets 102. Within formulations providing enhanced rigidity, Applicant has further noted an overall increase in material stability during multi-pass printing processes, thus improving print registration.

In the preferred set of chemical formulations for magnetizable layer 110, magnetizable material 115 preferably comprises ferrite powder, preferably strontium ferrite powder (SrFe₁₂O₁₉), alternately preferably barium ferrite powder (BaFe₁₂O₁₉). Ferrite powder preferably is obtained from Hoosier Magnetics, Inc. located in Ogdensburg, N.Y. (product number HM 410) (http://www.hoosiermagneticsinc.com/index.html). Alternately preferably, ferrite powder is obtained in recycled powder form from TDK Corporation (http://www.tdk.com/). Upon reading this specification, those with ordinary skill in the art will now appreciate that, under appropriate circumstances, considering such issues as design preference, manufacturer preference, cost, changing needs, future technologies, etc., other magnetizable materials such as, magnetic materials containing nickel, magnetic materials containing cobalt, magnetic materials containing gadolinium, other ferromagnetic materials, etc., may suffice. It is noted that higher-grade strontium ferrite and barium ferrite constituents are preferred for high-energy applications.

Preferred formulations for magnetizable layer 110 preferably further comprise from about one-tenth to about ten percent, by weight, surfactant 125. Upon reading this specification, those with ordinary skill in the art will now appreciate that, under appropriate circumstances, considering such issues as design preference, manufacturer preference, cost, changing needs, future technologies, etc., other weight percentage arrangements such as, for example, higher weight percentages, lower weight percentages, etc., may suffice.

Surfactant 125 (at least herein embodying wherein such at least one magnetizable sheet further comprises at least one interfacial-tension-reducer structured and arranged to reduce the interfacial tension between such at least one magnetizable-material and such at least one binder; and, at least herein embodying wherein such magnetizable-sheet means comprises interfacial-tension-reducer means for reducing the interfacial tension between such magnetizable-material means and such binder means) preferably comprises at least one polar region 150 and at least one nonpolar region 155, as shown. This arrangement preferably assists in producing surfactant properties. Nonpolar region 155 preferably comprises at least one hydrophobic chain. Surfactant 125 preferably comprises at least one biologically-derived polyester resin, preferably at least one polyester resin derived from soy, preferably at least one polyester resin derived from soy sold under the trademark BIOREZ™ 15062 preferably supplied from Advanced Image Resources, LLC located in Alpharetta, Ga. (http://www.air-toner.com/). BIOREZ™ 15062 (hereinafter BIOREZ™ 15062 will be referred to as “BioRez”) preferably comprises a liquid-glass transition (T_{g}) of 57° celcius and an acid value of 9.

Alternately preferably, surfactant 125 preferably comprises stearic acid. Alternately preferably, surfactant 125 comprises calcium stearate. Alternately preferably, surfactant 125 comprises at least one tackifying resin such as at least one abietic acid ester, at least one rosin ester, or at least one terpene phenolic resin. Such at least one rosin ester preferably comprises rosin esters sold under the trademark Foral® or Pentrex™. Alternately preferably, surfactant 125 comprises at least one styrene-acrylate copolymer such as Pliolite® AC-L. Alternately preferably, surfactant 125 preferably comprises at least one acrylate copolymer resin such as Pliolite® LV72. Upon reading this specification, those with ordinary skill in the art will now appreciate that, under appropriate circumstances, considering such issues as design preference, manufacturer preference, cost, changing needs, future technologies, etc., other types of surfactants such as, for example, surfactant mixtures, detergents, other fatty acids, other amphiphilic compounds, other surfactants, etc., may suffice.

Preferred formulations for magnetizable layer 110 preferably further comprise from about ten percent to about forty percent, by weight, first stiff binder 135, as shown. Upon reading this specification, those with ordinary skill in the art will now appreciate that, under appropriate circumstances, considering such issues as design preference, manufacturer preference, cost, changing needs, future technologies, etc., other weight percentage arrangements such as, for example, higher weight percentages, lower weight percentages, etc., may suffice.

First stiff binder 135 (at least herein embodying wherein such at least one binder comprises at least one first stiffener structured and arranged to stiffen such at least one magnetizable sheet; and, at least herein embodying wherein such binder means comprises first-stiffener means for stiffening such magnetizable-sheet means) preferably provides favorable stiffening properties to controlled-flexibility magnetic sheets 102 (see further details below). First stiff binder 135 preferably comprises at least one polyethylene polymer with crystalline properties, preferably at least one low-density polyethylene (LDPE), preferably at least one low-density polyethylene derived from post-manufacture plastic bag waste. Alternately preferably, first stiff binder 135 comprises at least one linear low-density polyethylene (LLDPE), preferably at least one linear low-density polyethylene derived from post-manufacture plastic bag waste. Alternately preferably, first stiff binder 135 comprises at least one mixture of at least one low-density polyethylene and at least one linear low-density polyethylene, preferably at least one mixture of at least one low-density polyethylene and at least one linear low-density polyethylene derived from post-manufacture plastic bag waste. Such post-manufacture plastic bag waste preferably comprises plastic bag waste sold under the trademark Ziploc® (see Table 1 though Table 7). Upon reading this specification, those with ordinary skill in the art will now appreciate that, under appropriate circumstances, considering such issues as design preference, manufacturer preference, cost, changing needs, future technologies, etc., other stiffening agents such as, for example, other stiffening polymeric binders, stiffening plastics, rubbers, polymeric resins, polymers derived from other sources, etc., may suffice.

Preferred formulations for magnetizable layer 110 preferably further comprise from about twelve percent to about twenty-two percent, by weight, second stiff binder 137, as shown. Upon reading this specification, those with ordinary skill in the art will now appreciate that, under appropriate circumstances, considering such issues as design preference, manufacturer preference, cost, changing needs, future technologies, etc., other weight percentage arrangements such as, for example, higher weight percentages, lower weight percentages, etc., may suffice.

Second stiff binder 137 (at least herein embodying wherein such at least one binder further comprises at least one second stiffener structured and arranged to stiffen such at least one magnetizable sheet) preferably further contributes favorable stiffening properties to controlled-flexibility magnetic sheets 102. Furthermore, second stiff binder 137 preferably comprises polar groups 160 which preferably assist in the adhesion of polar coatings applied to the surface of controlled-flexibility magnetic sheets 102. Second stiff binder 137 preferably comprises at least one polymer with crystalline properties, preferably at least one ethylene vinyl acetate (EVA) copolymer, preferably at least one film grade ethylene vinyl acetate (EVA) copolymer. Such at least one film grade ethylene vinyl acetate (EVA) copolymer preferably is obtained from Equistar (http://www.lyondellbasell.com/Aboutus/WorldWideLocations/) and is sold under the product name Ultrathene® UE62400. Upon reading this specification, those with ordinary skill in the art will now appreciate that, under appropriate circumstances, considering such issues as design preference, manufacturer preference, cost, changing needs, future technologies, etc., other stiffening agents such as, for example, other stiffening polymeric binders, stiffening plastics, rubbers, polymeric resins, etc., may suffice.

Preferred formulations for magnetizable layer 110 preferably further comprise about forty percent, by weight, of at least one flexible binder 140, as shown. Upon reading this specification, those with ordinary skill in the art will now appreciate that, under appropriate circumstances, considering such issues as design preference, manufacturer preference, cost, changing needs, future technologies, etc., other weight percentage arrangements such as, for example, higher weight percentages, lower weight percentages, etc., may suffice.

Flexible binder 140 (at least herein embodying wherein such at least one binder further comprises at least one flexible-binder structured and arranged to provide flexibility to such at least one magnetizable sheet) preferably contributes flexibility to resulting magnetic sheets 102. In addition, flexible binder 140 preferably comprises polar groups 165 which preferably assist in the adhesion of polar coatings applied to the surface of controlled-flexibility magnetic sheets 102. Flexible binder 140 preferably comprises at least one flexible thermoplastic polymer, preferably at least one chlorinated polyethylene elastomer (CPE), preferably at least one chlorinated polyethylene elastomer (CPE) comprising a chlorine content of about thirty percent. Such at least one chlorinated polyethylene elastomer (CPE) preferably is obtained from Alternative Rubber and Plastics, Inc. located in Amherst, N.Y. (http://www.altrubber.com/) (product number CM 301). In preferred formulations for polymeric matrix 122, chlorinated polyethylene elastomer preferably is present at about forty percent, by weight (see Table 1 through Table 7). Upon reading this specification, those with ordinary skill in the art will now appreciate that, under appropriate circumstances, considering such issues as design preference, manufacturer preference, cost, changing needs, future technologies, etc., other arrangements such as, for example, other flexible polymeric binders, flexible plastics, rubbers, polymeric resins, flexible thermoplastic resins, etc., may suffice.

Preferred compositions of polymeric matrix 122 preferably further comprises from about eight percent to about thirty percent, by weight, of at least one elastomeric binder 145, as shown. Upon reading this specification, those with ordinary skill in the art will now appreciate that, under appropriate circumstances, considering such issues as design preference, manufacturer preference, cost, changing needs, future technologies, etc., other weight percentage arrangements such as, for example, higher weight percentages, lower weight percentages, etc., may suffice.

Elastomeric binder 145 (at least herein embodying wherein such at least one binder further comprises at least one elastomeric-binder structured and arranged to provide elastomeric properties to such at least one magnetizable sheet) preferably contributes favorable elastomeric properties to controlled-flexibility magnetic sheets 102. Elastomeric binder 145 preferably comprises at least one low-density elastomeric polymer which assists with the loading of magnetizable material 115 in magnetizable layer 110. Such at least one low-density elastomeric polymer preferably comprises at least one low-density ethylene-octene copolymer, preferably at least one low-density ethylene-octene copolymer sold under the trademark ENGAGE™ 8200. Alternately preferably, such at least one low-density elastomeric polymer preferably comprises at least one low-density propylene elastomer, preferably at least one low-density low-density propylene elastomer sold under the trademark Vistamaxx™ 6102. Alternately preferably, such at least one low-density elastomeric polymer preferably comprises at least one mixture of such at least one low-density ethylene-octene copolymer sold under the trademark ENGAGE™ 8200 and such at least one low-density propylene elastomer sold under the trademark Vistamaxx™ 6102. ENGAGE™ 8200 preferably is supplied from Dow® chemical company (http://www.dow.com/) with corporate headquarters in Midland, Mich. Vistamaxx™ 6102 preferably is obtained from ExxonMobil Chemical (http://www.exxonmobilchemical.com/Chem-English/default.aspx) located in Houston, Tex. Elastomeric binder 145 preferably comprises a density in the range of about 0.86 g/cm³ to about 0.87 g/cm³. Upon reading this specification, those with ordinary skill in the art will now appreciate that, under appropriate circumstances, considering such issues as design preference, manufacturer preference, cost, changing needs, future technologies, etc., other arrangements such as, for example, other elastomeric binders, elastomeric plastics, rubbers, polymeric resins, elastomeric resins, etc., may suffice.

Tables 1 through Tables 7 outline seven examples of chemical formulations for magnetic sheets having enhanced rigidity. Tables 1 through Tables 3 present control formulations (prepared without surfactant 125). Tables 4 through Tables 7 illustrate examples for preferred chemical formulations for controlled-flexibility magnetic sheets 102 (prepared with surfactant 125), according to the preferred embodiment of the present invention.

TABLE 1
Example 1
Formula MF(S) 1053 R1 (control formulation)

| Material | Grade | Weight (lbs)¹ | Weight % |
|---|---|---|---|
| CPE | Jamplast CPE 130A | 15.24 | 39.08 |
| EVA | MI = 2,² VA = 18%,² | 4.93 | 12.64 |
| | Escorene Ultra LD | | |
| | 728² | | |
| ENGAGE | 8200 | 3.59 | 9.20 |
| Vistamaxx | V6102 | 10.31 | 26.44 |
| LDPE/LLDPE | Ziplock ® bag scrap | 4.93 | 12.64 |
| BioRez | 13062 | 0.00 | 0.00 |

| | | |
|---|---|---|
| Total | 39.00 | 100.00 |

¹Formula MF(S) 1053 R1 further contains 300 lbs 410 ferrite powder (Hoosier grade) and 55 lbs recycled ferrite powder (TDK grade).
²MI = equivalent melt index; VA = vinyl acetate content.

TABLE 2
Example 2
Formula BDR027 (control formulation)

| Material | Grade | Weight (lbs)¹ | Weight % |
|---|---|---|---|
| CPE | Jamplast CPE 130A | 15.05 | 39.08 |
| EVA | MI = 2,² VA = 18%,² | 4.87 | 12.64 |
| | Escorene Ultra LD | | |
| | 728² | | |
| ENGAGE | 8200 | 3.54 | 9.20 |
| Vistamaxx | V6102 | 7.35 | 19.08 |
| LDPE/LLDPE | Ziplock ® bag scrap | 7.70 | 20.00 |
| BioRez | 13062 | 0.00 | 0.00 |

| | | |
|---|---|---|
| Total | 38.50 | 100.00 |

¹Formula BDR027 further contains 300 lbs ferrite powder (Hoosier grade) and 55 lbs recycled ferrite powder (TDK grade).
²MI = equivalent melt index; VA = vinyl acetate content.

TABLE 3
Example 3
Formula BDR029 (control formulation)

| Material | Grade | Weight (lbs)¹ | Weight % |
|---|---|---|---|
| CPE | Jamplast CPE 130A | 15.24 | 39.08 |
| EVA | MI = 2,² VA = 18%,² | 4.93 | 12.64 |
| | Escorene Ultra LD 728 | | |
| ENGAGE | 8200 | 3.23 | 8.28 |
| Vistamaxx | V6102 | 0.00 | 0.00 |
| LDPE/LLDPE | Ziplock ® bag scrap | 15.60 | 40.00 |
| BioRez | 13062 | 0.00 | 0.00 |

| | | |
|---|---|---|
| Total | 39.00 | 100.00 |

¹Formula BDR029 further contains 250 lbs 410 ferrite powder (Hoosier grade) and 110 lbs recycled ferrite powder (TDK grade).
²MI = equivalent melt index; VA = vinyl acetate content.

TABLE 4
Example 4
Formula BDR030 (formulation for controlled-flexibility
magnetic sheet 102)

| Material | Grade | Weight (lbs)¹ | Weight % |
|---|---|---|---|
| CPE | Jamplast CPE 130A | 14.85 | 38.08 |
| EVA | MI = 2,² VA = 18%,² | 4.80 | 12.32 |
| | Escorene Ultra LD 728 | | |
| ENGAGE | 8200 | 3.50 | 8.96 |
| Vistamaxx | V6102 | 7.25 | 18.59 |
| LDPE/LLDPE | Ziplock ® bag scrap | 7.60 | 19.49 |
| BioRez | 13062 | 1.00 | 2.56 |

| | | |
|---|---|---|
| Total | 39.00 | 100.00 |

¹Formula BDR030 further contains 250 lbs 410 ferrite powder (Hoosier grade) and 110 lbs recycled ferrite powder (TDK grade).
²MI = equivalent melt index; VA = vinyl acetate content.

TABLE 5
Example 5
Formula BDR031 (formulation for controlled-flexibility
magnetic sheet 102)

| Material | Grade | Weight (lbs)¹ | Weight % |
|---|---|---|---|
| CPE | Jamplast CPE 130A | 14.85 | 38.57 |
| EVA | MI = 2,² VA = 18%,² | 4.80 | 12.48 |
| | Escorene Ultra LD 728 | | |
| ENGAGE | 8200 | 3.15 | 8.17 |
| Vistamaxx | V6102 | 0.00 | 0.00 |
| LDPE/LLDPE | Ziplock ® bag scrap | 15.20 | 39.48 |
| BioRez | 13062 | 0.50 | 1.30 |

| | | |
|---|---|---|
| Total | 38.50 | 100.00 |

¹Formula BDR031 further contains 300 lbs 410 ferrite powder (Hoosier grade) and 55 lbs recycled ferrite powder (TDK grade).
²MI = equivalent melt index; VA = vinyl acetate content.

TABLE 6
Example 6
Formula BDR032 (formulation for controlled-flexibility
magnetic sheet 102)

| Material | Grade | Weight (lbs)¹ | Weight % |
|---|---|---|---|
| CPE | Jamplast CPE 130A | 14.65 | 38.06 |
| EVA | MI = 2,² VA = 18%,² | 4.74 | 12.31 |
| | Escorene Ultra LD 728 | | |
| ENGAGE | 8200 | 3.11 | 8.07 |
| Vistamaxx | V6102 | 0.00 | 0.00 |
| LDPE/LLDPE | Ziplock ® bag scrap | 15.00 | 38.96 |
| BioRez | 13062 | 1.00 | 2.60 |

| | | |
|---|---|---|
| Total | 38.50 | 100.00 |

¹Formula BDR032 further contains 300 lbs 410 ferrite powder (Hoosier grade) and 55 lbs recycled ferrite powder (TDK grade).
²MI = equivalent melt index; VA = vinyl acetate content.

TABLE 7
Example 7
Formula BDR033 (formulation for controlled-flexibility
magnetic sheet 102)

| Material | Grade | Weight (lbs)¹ | Weight % |
|---|---|---|---|
| CPE | Jamplast CPE 130A | 15.03 | 38.06 |
| EVA | MI = 2,² VA = 18%,² | 4.86 | 12.31 |
| | Escorene Ultra LD 728 | | |
| ENGAGE | 8200 | 3.19 | 8.07 |
| Vistamaxx | V6102 | 0.00 | 0.00 |
| LDPE/LLDPE | Ziplock ® bag scrap | 15.39 | 38.96 |
| BioRez | 13062 | 1.03 | 2.60 |

| | | |
|---|---|---|
| Total | 39.50 | 100.00 |

¹Formula BDR033 further contains 150 lbs 410 ferrite powder (Hoosier grade) and 220 lbs recycled ferrite powder (TDK grade).
²MI = equivalent melt index; VA = vinyl acetate content.

In the above examples, CPE is chlorinated polyethylene and preferably comprises flexible binder 140. EVA is ethylene vinyl acetate and preferably comprises second stiff binder 137. ENGAGE comprises an ethylene-octene copolymer which preferably functions as elastomeric binder 145. Vistamaxx comprises a propylene elastomer which preferably functions as elastomeric binder 145. LDPE/LLDPE is a mixture of low-density polyethylene (LDPE) and linear low-density polyethylene (LLDPE) derived from Ziploc™ bag scrap and preferably functions as first stiff binder 135. BioRez is a polyester resin derived from soy oil and preferably functions as surfactant 125.

In specific reference to Formula MF(S) 1053 R1 (Table 1, control formulation prepared without surfactant 125), the formulation comprises about 39%, by weight, chlorinated polyethylene (CPE); about 13%, by weight, ethylene vinyl acetate (EVA); about 9%, by weight, ENGAGE; about 26%, by weight Vistamaxx; and about 13%, by weight of low-density polyethylene (LDPE) and linear low-density polyethylene (LLDPE), as shown.

In specific reference to Formula BDR027 (Table 2, control formulation prepared without surfactant 125), the formulation comprises about 39%, by weight, chlorinated polyethylene (CPE); about 13%, by weight, ethylene vinyl acetate (EVA); about 9%, by weight, ENGAGE; about 19%, by weight, Vistamaxx; and about 20%, by weight, low-density polyethylene (LDPE) and linear low-density polyethylene (LLDPE), as shown.

In specific reference to Formula BDR029 (Table 3, control formulation prepared without surfactant 125), the formulation comprises about 39%, by weight, chlorinated polyethylene (CPE); about 13%, by weight, ethylene vinyl acetate (EVA); about 8%, by weight, ENGAGE; and about 40%, by weight, low-density polyethylene (LDPE) and linear low-density polyethylene (LLDPE), as shown.

In specific reference to Formula BDR030 for controlled-flexibility magnetic sheet 102 (Table 4), the preferred formulation comprises about 38%, by weight, chlorinated polyethylene (CPE); about 12%, by weight, ethylene vinyl acetate (EVA); about 9%, by weight, ENGAGE; about 19%, by weight, Vistamaxx; about 19%, by weight, low-density polyethylene (LDPE) and linear low-density polyethylene (LLDPE); and about 2.6%, by weight, BioRez surfactant, as shown.

In specific reference to Formula BDR031 for controlled-flexibility magnetic sheet 102 (Table 5), the preferred formulation comprises about 39% chlorinated polyethylene (CPE); about 12%, by weight, ethylene vinyl acetate (EVA); about 8%, by weight, ENGAGE; about 39%, by weight, low-density polyethylene (LDPE) and linear low-density polyethylene (LLDPE); and about 1.3%, by weight, BioRez surfactant, as shown.

In specific reference to Formula BDR032 for controlled-flexibility magnetic sheet 102 (Table 6), the formulation comprises about 38%, by weight, chlorinated polyethylene (CPE); about 12%, by weight, ethylene vinyl acetate (EVA); about 8%, by weight, ENGAGE; about 39%, by weight, low-density polyethylene (LDPE) and linear low-density polyethylene (LLDPE); and about 2.6%, by weight, BioRez surfactant, as shown.

In specific reference to Formula BDR033 for controlled-flexibility magnetic sheet 102 (Table 7), the formulation comprises about 38%, by weight, chlorinated polyethylene (CPE); about 12%, by weight, ethylene vinyl acetate (EVA); about 8%, by weight, ENGAGE; about 39%, by weight, low-density polyethylene (LDPE) and linear low-density polyethylene (LLDPE); and about 2.6%, by weight, BioRez surfactant, as shown.

Table 8 lists the physical properties of magnetic sheets (control magnetic sheets) prepared according to the formulations listed in Table 1 through Table 3. Table 9 lists the physical properties of controlled-flexibility magnetic sheets 102 prepared according to the preferred formulations provided in Table 4 through Table 7. Table 10 shows the peel adhesion results (see glossary) for magnetic sheets (control magnetic sheets) and controlled-flexibility magnetic sheets 102 prepared according to the formulations provided in Table 1 through Table 7.

TABLE 8
Physical Properties for Magnetic Sheets (Control Sheets)

| Formula | MF(S) 1053 R1 | MF(S) 1053 R1 | BDR027 | BDR029 |
|---|---|---|---|---|
| Ferrite Powder Lot(s) | HSr³ lot 1581, | | Hsr³ lot 1589, | HSr³ lot 1581 |
| (amount) | bag 9 (300 lbs) | | bag 1 | bag 9 (250 lbs) |
| TDK⁴ (amount) | Run 315 | | (300 lbs) | Run 315 |
| | bag 10 | | (55 lbs) | bag 10 |
| | (55 lbs) | | | (110 lbs) |
| Formula/Binder | MF(S) 1053 R1 | | Premix² | BDR029 |
| (amount) | (39 lbs) | | (38.5 lbs) | (39 lbs) |
| Mixer Blow Out | 205 | | 200 | 205 |
| Temperature | | | | |
| (Fahrenheit) | | | | |
| Mixer Dump | 205 | | 260 | 205 |
| Temperature | | | | |
| (Fahrenheit) | | | | |
| Calender TCU¹ | Top 175; | | Top 195; | Top 175; |
| Settings (Farenheit) | Bottom 205 | | Bottom 225 | Bottom 205 |

Initial

| | | | | |
|---|---|---|---|---|
| Tensile Strength (psi) | 891 | 822 | 1088 | 1644 |
| Elongation at Break | 15.1 | 30.4 | 12.3 | 16.9 |
| (%) | | | | |
| Yield Strength (psi) | 998 | 912 | 1114 | 1679 |
| Elongation at Yield | 9.4 | 9.9 | 8.3 | 12.4 |
| (%) | | | | |
| Modulus of Rigidity | 106 | | 134 | 135 |
| (psi) | | | | |

24 hr dwell

| | | | | |
|---|---|---|---|---|
| Tensile Strength (psi) | 938 | 835 | 917 | 1436 |
| Elongation at Break | 13.7 | 20.3 | 9.5 | 15.8 |
| (%) | | | | |
| Yield Strength (psi) | 1058 | 938 | 1060 | 1548 |
| Elongation at Yield | 8.7 | 9.2 | 7.2 | 5.5 |
| (%) | | | | |
| Modulus of Rigidity | 122 | | 148 | 284 |
| (psi) | | | | |
| Millage | 0.011 | 0.014 | 0.011 | 0.015 |
| Bᵣ (G) | 1593 | 1613 | 1580 | 1586 |
| H_{c} (Oe) | 1091 | 1061 | 1051 | 1052 |
| H_{ci} (Oe) | 1791 | 1671 | 1720 | 1761 |
| BHₘₐₓ (MGOe) | 0.49 | 0.50 | 0.43 | 0.48 |
| Relative Density | 3.55 | 3.51 | 3.54 | 3.59 |
| (g/cm³) | | | | |
| Shore Durometer | 56 | 60 | 60 | 71 |
| Hardness | | | | |
| (Shore A) | | | | |
| Block (2.00 lbs/2 in.) | 1.04 | | 0.607 | 0.100 |
| Flexibility with fold | | | | |
| CD&MD (initial) | | | | |
| Flexibility with fold | CD: OK, MD: | | CD: very slight | CD: OK, MD: |
| CD&MD (24 hr | pinholes | | pinhole, MD: | cracks |
| dwell) | | | pinholes and | |
| | | | slight cracking | |
| Flexibility ¼″ Rod | CD and MD: | passes CD/MD | CD and MD: | CD: OK, MD: |
| CD & MD⁵ (24 hr | OK | | OK | cracks (96 hr |
| dwell) | | | | dwell) |

¹TCU = temperature control units.
²Binders are pre-mixed before adding ferrite powder.
³Ferrite powder obtained from Hoosier Magnetics, Inc.
⁴Ferrite powder obtained from TDK Corporation,
⁵Flexibility test in which the magnetic sheet is bent around a one-quarter inch diameter cylindrical rod.

TABLE 9
Physical Properties for Rigid Magnetic Sheets

| Formula | BDR030 | BDR031 | BDR032 | BDR033 |
|---|---|---|---|---|
| Ferrite Powder Lot(s) | Hsr² lot 1581 | (300 lbs) | | |
| (amount) | bag 9 (250 lbs) | | | |
| TDK³ and amount | Run 315 bag 10 | (55 lbs) | | |
| | (110 lbs) | | | |
| Formula/Binder (amount) | BDR030 (39 lbs) | BDR031 (38.5 lbs) | | |
| Mixer Blow Out | 205 | | | |
| Temperature (Fahrenheit) | | | | |
| Mixer Dump Temperature | 255 | | | |
| (Fahrenheit) | | | | |
| Calender TCU¹ Settings | Top 175; | | | |
| (Farenheit) | Bottom 205 | | | |

Initial

| Tensile Strength (psi) | 1178 ± 13 | | 1090 | 1289 |
|---|---|---|---|---|
| Elongation and Break (%) | 34.3 ± 3.3 | | 16.7 | 20.5 |
| Yield Strength (psi) | 1185 | | 1138 | 1378 |
| Elongation at Yield (%) | 33.7 | | 9.4 | 14.7 |
| Modulus of Rigidity (psi) | 35.2 | | | |
| 24 hr dwell | | (72 hr dwell) | (24 hr dwell) | (24 hr dwell) |
| Tensile Strength (psi) | 1194 | 1509 | 1055 | 1451 |
| Elongation at Break (%) | 25.3 | 19.1 | 11.2 | 26.4 |
| Yield Strength (psi) | 1208 | 1565 | 1178 | 1467 |
| Elongation at Yield (%) | 8.5 | 16.0 | 7.0 | 26.0 |
| Modulus of Rigidity (psi) | 143 | 107 | | |
| Millage | 0.013 | 0.015 | 0.0100 | 0.014 |
| Block (2.00 lbs/2 in.) | 0.628 | 0.497 | 0.705 | 0.416 |
| Bᵣ 1500 (G) | 1582 | 1607 | 1615 | 1455 |
| H_{c} (Oe) | 1047 | 1048 | 1058 | 888.8 |
| H_{ci} (Oe) | 1743 | 1668 | 1694 | 1452 |
| BHₘₐₓ (MGOe) | 0.47 | 0.49 | 0.49 | 0.37 |
| Relative Density (g/cm³) | 3.58 | 3.58 | 3.57 | 3.57 |
| Shore Durometer Hardness | 65 | 71 | 61 | 66 |
| (Shore A) | | | | |
| Flexibility with fold | | | | |
| CD&MD (initial) | | | | |
| Flexibility with fold | CD: OK, MD: | CD: OK, MD: | | |
| CD&MD (24 hr dwell) | pinholes | cracks (64 hr | | |
| | | dwell) | | |
| Flexibility ¼″ Rod | CD and MD: | CD and MD: | Passes CD/MD | Passes CD/MD |
| CD&MD⁴ (24 hr dwell) | OK | OK (64 hr and | | |
| | | 168 hr dwell) | | |

¹TCU = temperature control units.
²Ferrite powder obtained from Hoosier Magnetics, Inc.
³Ferrite powder obtained from TDK Corporation.
⁴Flexibility test in which a magnetic sheet is bent around a one-quarter inch diameter cylindrical rod.

TABLE 10
Peel Adhesion Results for Rigid Magnetic Sheets

| | Weight | | Peel | |
|---|---|---|---|---|
| | Percent | | Adhesion¹ | |
| Formula | BioRez | Dwell time | (oz/in) | 95% Confidence |
| BDR030² | 2.6 | 15 min | 21.7 ± 0.2 | Same |
| BDR027² | 0.0 | 15 min | 21.4 ± 1.3 | |
| BDR030² | 2.6 | 15 min | 21.7 ± 0.2 | Same |
| MF(S) 1053 R1² | 0.0 | 15 min | 20.6 ± 1.0 | |
| BDR030² | 2.6 | 96 hr | 28.6 ± 1.1 | Same |
| BDR027² | 0.0 | 96 hr | 27.6 ± 2.7 | |
| BDR030² | 2.6 | 96 hr | 28.6 ± 1.1 | Same |
| MF(S) 1053 R1² | 0.0 | 96 hr | 27.7 ± 1.1 | |
| BDR031³ | 1.3 | 72 hr | 34.6 ± 1.9 | Different (24%) |
| MF(S) 1053 R1³ | 0.0 | 72 hr | 27.9 ± 0.5 | |
| BDR032² | 2.6 | | 34.3 ± 0.6 | Different (2.4%) |
| MF(S) 1053 R1² | 0.0 | | 33.5 ± 0.4 | |
| BDR033² | 2.6 | | 32.7 ± 1.4 | Same |
| MF(S) 1053 R1² | 0.0 | | 33.5 ± 0.4 | |
| BDR032² | 2.6 | | 34.3 ± 0.6 | Different (4.9%) |
| BDR033² | 2.6 | | 32.7 ± 1.4 | |
| Oven BDR032^{2,4} | 2.6 | | 20.8 ± 1.2 | Same |
| OvenMF(S) 1053 | 0.0 | | 20.3 ± 0.2 | |
| R1^{2,4} | | | | |
| Oven BDR033^{2,4} | 2.3 | | 24.1 ± 1.6 | Different (19%) |
| Oven MF(S) 1053 | 0.0 | | 20.3 ± 0.2 | |
| R1^{2,4} | | | | |
| Oven BDR032^{2,4} | 2.6 | | 20.8 ± 1.2 | Different (16%) |
| Oven BDR033² | 2.6 | | 24.1 ± 1.6 | |

¹See glossary.
²Samples were hand laminated.
³Samples were laminated in production.
⁴Oven temperature = 150 degrees Celsius.

Applicant has noted that surfactant 125 allows for a higher loading of magnetizable material 115 in magnetizable layer 110 (this arrangement at least herein embodying wherein such at least one interfacial-tension-reducer comprises at least one magnetizable-material-loading-capacity-enhancer structured and arranged to enhance the capacity for loading such at least one magnetizable-material in such at least one magnetizable sheet). More particularly, applicant has noted higher loadings of strontium ferrite in magnetizable layer 110 in the presence of surfactant 125. Such higher loadings of strontium ferrite in the presence of surfactant 125 is indicated by the increased flexibility of controlled-flexibility magnetic sheets 102 prepared in the presence of surfactant 125. In particular, increased flexibility of controlled-flexibility magnetic sheets 102 is indicated by higher elongations of controlled-flexibility magnetic sheets 102 prepared in the presence of surfactant 125. Applicant has noted that magnetic sheet flexibility is correlated with the amount of ferrite powder loaded into magnetic sheets. Within formulations providing enhanced rigidity, Applicant has further noted an overall increase in material stability during multi-pass printing processes, thus improving print registration.

Applicant has further noted improved dispersion of magnetizable material 125 in magnetizable layer 110 in the presence of surfactant 125 (this arrangement at least herein embodying wherein such at least one interfacial-tension-reducer further comprises at least one disperser structured and arranged to disperse such at least one magnetizable-material in such at least one magnetizable sheet). Applicant proposes surfactant 125 mediates the interaction between magnetizable material 115, which is relatively polar, and polymeric binders 130, which comprise nonpolar properties. Surfactant 125 preferably mediates the interaction between relatively polar magnetizable material 115 and relatively nonpolar polymeric binders 130 by virtue of its dual polar nature, as best shown in FIG. 3. Surfactant 125 preferably may form at least one micelle structure 170 around magnetizable material 115, effectively creating a hydrophobic (nonpolar) layer on its surface, as shown. This arrangement preferably reduces the interfacial tension between polar magnetizable material 115 and nonpolar polymeric binders 130 present in polymeric matrix 122, as shown, leading to enhanced loading of magnetizable material 115 in magnetizable layer 110. In addition, this arrangement could also enhance the dispersion (decrease clustering) of magnetizable material 115 in magnetizable layer 110.

Applicant has further noted increased magnetic pull strengths in controlled-flexibility magnetic sheets 102 prepared with surfactant 125. Such increased magnetic pull strengths in controlled-flexibility magnetic sheets 102 prepared with surfactant 125 results from the ability to load more magnetizable material 115 in magnetizable layer 110.

Applicant has further noted enhanced loading of stiff binders 132 in magnetizable layer 110 in the presence of surfactant 125 (this arrangement at least herein embodying wherein such at least one interfacial-tension-reducer further comprises at least one binder-capacity-loading-enhancer structured and arranged to enhance the capacity for loading of such at least one binder in such at least one magnetizable sheet). Such enhanced loading of stiff binders 132 is indicated by the performance of controlled-flexibility magnetic sheets 102 in the flexibility test in which controlled-flexibility magnetic sheets 102 are bent around a one-quarter inch diameter cylindrical rod (see Table 8 and Table 9). For example, controlled-flexibility magnetic sheets 102 prepared using formula BDR031, formula BDR032, and formula BDR033 (see Table 5 through Table 7) containing BioRez surfactant all pass the flexibility test, whereas a magnetic sheet prepared using control formula BDR029 (see Table 3) does not (see Table 8 and Table 9). Applicant has noted that the performance of magnetic sheets in the flexibility test is correlated with the degree of loading of stiff binder 132.

Applicant has proposed that the loading of stiff binders 132 is enhanced by virtue of reduced interfacial tension between stiff binders 132 and magnetizable material 115 in the presence of surfactant 125, according to the mechanism described above and illustrated in FIG. 3. The increased capacity to load stiff binders 132 in magnetizable layer 110 preferably allows for the production of controlled-flexibility magnetic sheets 102 with increased stiffness.

Applicant has further noted that controlled-flexibility magnetic sheets 102 prepared with surfactant 125 maintain an adequate degree of flexibility, as measured by the fold test (measures ability to bend before breakage occurs) and by tensile elongation measurements (see glossary). Applicant has also noted an increase elongation in controlled-flexibility magnetic sheet 102 in the presence of surfactant 125, as measured by percent elongation at break elongation at yield (see glossary). Applicant has further noted that the incorporation of surfactant 125 leads to an increase in the toughness (ability to absorb energy and deform plastically) and tear strength (resistance to tear) in controlled-flexibility magnetic sheets 102 (see glossary).

The increase in toughness of controlled-flexibility magnetic sheets 102 prepared with surfactant 125 is indicated by higher elongations while maintaining equal or higher tensile strengths, when comparing magnetic sheets of approximately the same thickness. As one illustrative example, the values for elongation at break and tensile strength for a control magnetic sheet prepared using formula BDR029 were 15.8% and 1436 psi, respectively, at 24 hr dwell time (see Table 8), whereas the values for elongation at break and tensile strength for a controlled-flexibility magnetic sheet 102 prepared using formula BDR031 containing 1.3% BioRez surfactant were 19.1% and 1509 psi, respectively, at 24 hr dwell time (see Table 9). With the exception of BioRez, the weight percentages of all other components in formula BDR029 and formula BDR031 are approximately equivalent (within 1% variation) (see Table 3 and Table 5), supporting that the higher elongation results from the presence of BioRez surfactant in formula BDR031. A second illustrative example of improved tear strength associated with the presence of the surfactant is provided in Table 11. Applicant has further noted an increase in yield strength (see glossary) in controlled-flexibility magnetic sheets 102 prepared with surfactant 125.

In addition, applicant has noted an increase in breakstress (measure of the amount of stress required to cause breakage) in controlled-flexibility magnetic sheets 102 prepared with surfactant 125. The increase in breakstress in controlled-flexibility magnetic sheets 102 prepared with surfactant 125 is indicated by the increase in tensile strength at break for controlled-flexibility magnetic sheet 102 prepared using formula BDR030 containing about 2.6% BioRez surfactant, compared with a control magnetic sheet prepared using formula BDR027. With the exception of BioRez, the weight percentages of all other components in formula BDR027 and BDR030 are approximately equivalent (within 1% variation) (see Table 2 and Table 4), supporting that the increase in tensile strength at break results from the presence of BioRez surfactant in formula BDR030. Similarly, an increase in tensile strength at break was also observed for controlled-flexibility magnetic sheet 102 prepared using formula BDR031 containing 1.3% BioRez, compared with a control magnetic sheet prepared using formula BDR029.

In addition, applicant has noted an increase in hardness in controlled-flexibility magnetic sheets 102 prepared with surfactant 125. Applicant has noted that the increase in hardness of controlled-flexibility magnetic sheets 102 prepared with surfactant 125 relates to the enhanced capability to load stiff binders 132.

The increase in toughness, tear strength, yield strength, breakstress, and hardness in controlled-flexibility magnetic sheets 102 prepared with surfactant 125 may be due to intrinsic stiffening properties of surfactant 125, the interaction of surfactant 125 with polymeric binders 130, and/or the ability of surfactant 125 to enhance the loading of stiff binders 132.

Applicant has further noted that surfactant 125 decreases the viscosity of formulations for controlled-flexibility magnetic sheets 102 at the melting temperature of the magnetic sheet melting, due to the flow properties of BioRez surfactant compared with stiff binders 132.

Applicant has further noted that the incorporation of surfactant 125 in controlled-flexibility magnetic sheets 102 increases the adhesion of polar coatings laminated on the surface of magnetizable layer 110 (see Table 10) (this arrangement at least herein embodying wherein such at least one interfacial-tension-reducer further comprises at least one adhesion-promoter structured and arranged to promote the adhesion of such at least one indicia-acceptor to such at least one surface of such at least one magnetizable sheet). As an example, the peel adhesion (see glossary for definition) measured for a laminated coating increased from about 28 ounces per inch (oz/in) for a control magnetic sheet prepared using formula MF(S) 1053 R1 (see Table 1) to about 35 ounces per inch (oz/in) for a controlled-flexibility magnetic sheet 102 prepared using formula BDR031 containing 1.3%, by weight, BioRez surfactant (see Table 5 and Table 10). Applicant proposes that surfactant 125 enhances the adhesion of coatings by participating in favorable polar interactions with such coatings.

Applicant has noted an increase in stiffness in controlled-flexibility magnetic sheets 102 formed with first stiff binder 135 (see FIG. 4). Applicant has further noted an increase in tensile strength (maximum amount of tensile stress which can be applied without breaking) in controlled-flexibility magnetic sheets 102 prepared with stiff binder 135 (see FIG. 4). Applicant has proposed that the increase in stiffness and tensile strength results, at least in part, from the crystalline properties of the preferred stiff binders 135 low-density polyethylene and linear low-density polyethylene, which promotes their self-association in a regular, rigid packing order in solid materials, as depicted in FIG. 3.

FIG. 4 shows a data graph, illustrating the increase in modulus of rigidity and tensile strength in magnetic sheets prepared with increasing weight percentages of first stiff binder 135. As shown in FIG. 4, the values for modulus of rigidity, which reflects the stiffness of a sample (see glossary), and the values for tensile strength (see glossary) both increase with increasing weight percent of first stiff binder 135 in three magnetic sheets prepared using formula MF(S) 1053 R1 (comprising about 12%, by weight, stiff binder 135 as low-density polyethylene and linear low-density polyethylene), formula BDR027 (comprising about 20%, by weight, stiff binder 135 as low-density polyethylene and linear low-density polyethylene), and formula BDR029 (about 40%, by weight, stiff binder 135 low-density polyethylene and linear low-density polyethylene).

Example 8 of table 11 outlines a preferred chemical formulation for a magnetic sheet having enhanced tear strength. Applicant noted an association between enhanced tear strength and the improved elongation and toughness of controlled-flexibility magnetic sheets 102 containing surfactant 125 in combination with the below-noted component loadings. Table 12 provides a listing of physical properties of the resulting tear resistant magnetic sheet formula of Table 11.

TABLE 11
Example 8
Formula 1080 (formulation for tear-resistant controlled-flexibility
magnetic sheet 102)

| Material | Grade | Weight (lbs)¹ | Weight % |
|---|---|---|---|
| CPE | Alternative Rubber | 17.00 | 39.56 |
| | CPE CM 301 | | |
| EVA | MI = 2,² VA = 18%,² | 5.30 | 12.33 |
| | Escorene Ultra LD 728 | | |
| ENGAGE | 8200 | 4.60 | 10.74 |
| Vistamaxx | V6102 | 11.15 | 0.00 |
| LDPE/LLDPE | Ziplock ® bag scrap | 3.95 | 9.16 |
| BioRez | 13062 | 1.00 | 2.33 |

| | | |
|---|---|---|
| Total | 43.00 | 100.00 |

¹Formula 1080 further contains 200 lbs 410 Strontium Ferrite Powder (Hoosier sheet grade), 100 lbs 410 Strontium Ferrite (Hoosier extrusion grade), and 55 lbs of TDK.

TABLE 12
Physical Properties of Tear Resistant Magnetic Sheet - Formula 1080

Formula 1080

24 hr dwell

| | |
|---|---|
| Tensile Strength (PSI) | 804 |
| Elongation at Break (%) | 33.9 |
| Yield Strength (PSI) | 906 |
| Elongation at Yield (%) | 9.9 |
| Modulus of Rigidity (PSI) | 92 |
| Millage | 0.0105 |

Preferred formulations of magnetizable layer 110 preferably are prepared by mixing magnetizable material 115, preferably in powdered form, with polymeric binders 130 and surfactant 125. Mixing is preferably performed at 290 degrees Fahrenheit (F). Magnetizable layer 110, polymeric binders 130, and surfactant 125 preferably are mixed in any order. The resultant composition preferably is shaped into a sheet by an extrusion process or a calendering method. Magnetizable layer 110 preferably is extruded (or shaped by a calendering method) to a final thickness A (see FIG. 1) in the range of between about ten mil (about one-quarter of a millimeter) to about twenty mil (about half of a millimeter). Upon reading this specification, those with ordinary skill in the art will now appreciate that, under appropriate circumstances, considering such issues as design preference, manufacturer preference, cost, changing needs, future technologies, etc., other types of magnetic sheet thicknesses such as, for example, thinner magnetic sheets, thicker magnetic sheets, etc., may suffice.

Following extrusion (or shaping by a calendering method), indicia-accepting coating 104 preferably may be sprayed-on or fluid-applied to at least one surface of magnetizable layer 110, as shown in FIG. 1. Alternately preferably, an alternative indicia-accepting coating may be applied by lamination to at least one surface of magnetizable layer 110. The resulting controlled-flexibility magnetic sheet 102 preferably may be subsequently processed by guillotine cutting and/or printing on indicia-accepting coating 104 by inserting into a commercial printer. Magnetizable layer 110 preferably is magnetized by placement in a magnetic field, either before or after application of indicia-accepting coating 104, and either before or after any cutting or printing processes.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1. A system, relating to providing at least one magnetic sheet, comprising:
a) at least one magnetizable sheet structured and arranged to provide at least one permanent magnetic field upon magnetization by at least one magnetic-field source;
b) wherein said at least one magnetizable sheet comprises at least one magnetizable-material structured and arranged to be magnetized by such at least one magnetic-field source;
c) wherein said at least one magnetizable sheet further comprises at least one binder structured and arranged to bind said at least one magnetizable-material in said at least one magnetizable sheet;
d) wherein said at least one magnetizable sheet further comprises at least one interfacial-tension-reducer structured and arranged to reduce the interfacial tension between said at least one magnetizable-material and said at least one binder;
e) wherein said at least one binder comprises at least one first stiffener structured and arranged to stiffen said at least one magnetizable sheet; and
f) wherein said at least one magnetizable sheet provides a favorable balance of stiffness and flexibility for enhancing the handling of said at least one magnetizable sheet with commercial printers, cutting tools, and processing equipment required for the manufacture of said at least one magnetizable sheet.

2. The system, according to claim 1, wherein said at least one interfacial-tension-reducer comprises at least one magnetizable-material-loading-capacity-enhancer structured and arranged to enhance the capacity for loading said at least one magnetizable-material in said at least one magnetizable sheet.

3. The system, according to claim 2, wherein said at least one interfacial-tension-reducer further comprises at least one binder-capacity-loading-enhancer structured and arranged to enhance the capacity for loading of said at least one binder in said at least one magnetizable sheet.

4. The system, according to claim 3, wherein said at least one interfacial-tension-reducer further comprises at least one disperser structured and arranged to disperse said at least one magnetizable-material in said at least one magnetizable sheet.

5. The system, according to claim 4, wherein said at least one interfacial-tension-reducer comprises at least one tear-resistance-enhancer structured and arranged to enhance the ability of said at least one magnetizable sheet to resist tearing.

6. The system, according to claim 5, wherein said at least one interfacial-tension-reducer comprises at least one polyester resin derived from soy.

7. The system, according to claim 5, wherein said at least one interfacial-tension-reducer is selected from the group consisting of at least one polyester resin derived from soy, stearic acid, calcium stearate, at least one abeitic acid ester, at least one rosin ester, at least one terpene phenolic ester, at least one styrene-acrylate copolymer, and at least one acrylate copolymer resin.

8. The system, according to claim 5, wherein said at least one magnetizable sheet further comprises:
a) at least one indicia-acceptor structured and arranged to accept at least one indicia on at least one surface of said at least one magnetizable sheet;
b) wherein said at least one indicia-acceptor is applied to such at least one surface of said at least one magnetizable sheet.

9. The system, according to claim 6, wherein such at least one polyester resin is present from about one-tenth of a percent to about ten percent, by weight, in said at least one magnetizable sheet.

10. The system, according to claim 7, wherein said at least one interfacial-tension-reducer is present from about one-tenth of a percent to about ten percent, by weight, in said at least one magnetizable sheet.

11. The system, according to claim 8, wherein said at least one interfacial-tension-reducer further comprises at least one adhesion-promoter structured and arranged to promote the adhesion of said at least one indicia-acceptor to such at least one surface of said at least one magnetizable sheet.

12. The system, according to claim 3, wherein said at least one first stiffener is selected from the group consisting of low-density polyethylene, linear low-density polyethylene, and at least one mixture of such low-density polyethylene and such linear low-density polyethylene.

13. The system, according to claim 12, wherein said at least one first stiffener is present from about ten percent to about forty percent, by weight, in said at least one magnetizable sheet.

14. The system, according to claim 13, wherein said at least one first stiffener is obtained from post-manufacture plastic bag waste.

15. The system, according to claim 12, wherein said at least one binder further comprises at least one second stiffener structured and arranged to stiffen said at least one magnetizable sheet.

16. The system, according to claim 15, wherein said at least one second stiffener comprises at least one ethylene vinyl acetate copolymer.

17. The system, according to claim 16, wherein such at least one ethylene vinyl acetate copolymer is present from about twelve to about twenty-two percent, by weight, in said at least one magnetizable sheet.

18. The system, according to claim 12, wherein said at least one binder further comprises at least one elastomeric-binder structured and arranged to provide elastomeric properties to said at least one magnetizable sheet.

19. The system, according to claim 18, wherein said at least one elastomeric-binder is selected from the group consisting of at least one ethylene-octene copolymer, and least one propylene-based elastomer, and at least one mixture of such at least one ethylene-octene copolymer and such at least one propylene-based elastomer.

20. The system, according to claim 19, wherein said at least one elastomeric binder is present from about eight percent to about thirty percent, by weight, in said at least one magnetizable sheet.

21. The system, according to claim 19, wherein said at least one binder further comprises at least one flexible-binder structured and arranged to provide flexibility to said at least one magnetizable sheet.

22. The system, according to claim 21, wherein said at least one flexible-binder comprises at least one chlorinated polyethylene elastomer.

23. The system, according to claim 22, wherein such at least one chlorinated polyethylene elastomer is present at about forty percent, by weight, in said at least one magnetizable sheet.

24. The system, according to claim 19, wherein said at least one magnetizable-material comprises at least one ferrite powder selected from the group consisting of strontium ferrite and barium ferrite.

25. A system, relating to providing at least one magnetic sheet, comprising:
a) at least one magnetizable sheet structured and arranged to provide at least one permanent magnetic field upon magnetization by at least one magnetic-field source;
b) wherein said at least one magnetizable sheet comprises at least one magnetizable-material structured and arranged to be magnetized by such at least one magnetic-field source;
c) wherein said at least one magnetizable sheet further comprises at least one binder structured and arranged to bind said at least one magnetizable-material in said at least one magnetizable sheet;
d) wherein said at least one magnetizable sheet further comprises at least one interfacial-tension-reducer structured and arranged to reduce the interfacial tension between said at least one magnetizable-material and said at least one binder;
e) wherein said at least one binder comprises at least one first-stiffener structured and arranged to stiffen said at least one magnetizable sheet;
f) wherein said at least one interfacial-tension-reducer comprises at least one magnetizable-material-loading-enhancer structured and arranged to enhance the loading of said at least one magnetizable-material in said at least one magnetizable sheet;
g) wherein said at least one interfactial-tension-reducer further comprises at least one binder-loading-enhancer structured and arranged to enhance the loading of said at least one binder in said at least one magnetizable sheet;
h) wherein said at least one interfacial-tension-reducer comprises at least one polyester resin derived from soy;
i) wherein said at least one first-stiffener is selected from the group consisting of low-density polyethylene, linear low-density polyethylene, and at least one mixture of such low-density polyethylene and such linear low-density polyethylene;
j) wherein said at least one first-stiffener is obtained from post-manufacture plastic bag waste;
k) wherein said at least one binder further comprises at least one second stiffener structured and arranged to stiffen said at least one magnetizable sheet;
l) wherein said at least one second stiffener comprises at least one ethylene vinyl acetate copolymer;
m) wherein said at least one binder further comprises at least one elastomeric-binder structured and arranged to provide elastomeric properties to said at least one magnetizable sheet;
n) wherein said at least one elastomeric-binder is selected from the group consisting of at least one ethylene-octene copolymer, and least one propylene-based elastomer, and at least one mixture of such at least one ethylene-octene copolymer and such at least one propylene-based elastomer;
o) wherein said at least one binder further comprises at least one flexible-binder structured and arranged to provide flexibility to said at least one magnetizable sheet;
p) wherein said at least one flexible-binder comprises at least one chlorinated polyethylene elastomer;
q) wherein said at least one magnetizable-material comprises at least one ferrite powder selected from the group consisting of strontium ferrite and barium ferrite; and
r) wherein said at least one magnetizable sheet provides a favorable balance of stiffness and flexibility for enhancing the handling of said at least one magnetizable sheet with commercial printers, cutting tools, and processing equipment required for the manufacture of said at least one magnetizable sheet.

26. A system, relating to providing at least one magnetic sheet, comprising:
a) magnetizable-sheet means for providing at least one permanent magnetic field upon magnetization by at least one magnetic-field source;
b) wherein said magnetizable-sheet means comprises magnetizable-material means for being magnetized by such at least one magnetic-field source;
c) wherein said magnetizable-sheet means comprises binder means for binding said magnetizable-material means in said magnetizable-sheet means;
d) wherein said magnetizable-sheet means comprises interfacial-tension-reducer means for reducing the interfacial tension between said magnetizable-material means and said binder means;
e) wherein said binder means comprises first-stiffener means for stiffening said magnetizable-sheet means;
f) wherein said magnetizable-sheet means provides a favorable balance of stiffness and flexibility for enhancing the handling of said at least one magnetizable sheet with commercial printers, cutting tools, and processing equipment required for the manufacture of said at least one magnetizable sheet.

27. A system, relating to providing at least one magnetic sheet, comprising:
a) at least one magnetizable sheet structured and arranged to provide at least one magnetic field upon magnetization by at least one magnetic field source, comprising
i) at least one magnetizable material selected from the group consisting of barium ferrite and strontium ferrite,
ii) from about one-tenth of a percent to about ten percent, by weight, of at least one surfactant selected from the group consisting of at least one polyester resin derived from soy, stearic acid, calcium stearate, at least one abeitic acid ester, at least one rosin ester, at least one terpene phenolic ester, at least one styrene-acrylate copolymer, and at least one acrylate copolymer,
iii) from about ten percent to about forty percent, by weight, of at least one first stiff binder selected from the group consisting of low-density polyethylene, linear low-density polyethylene, and at least one mixture of such low-density polyethylene and such linear low-density polyethylene,
iv) from about twelve percent to about twenty-two percent, by weight, of at least one ethylene vinyl acetate copolymer,
v) about forty percent, by weight, of chlorinated polyethylene elastomer;
vi) from about eight percent to about thirty percent, by weight, of at least one elastomeric binder selected from the group consisting of at least one low-density ethylene-octene copolymer, at least one low-density propylene elastomer, and at least one mixture of such at least one low-density ethylene-octene copolymer and such at least one low-density propylene elastomer, and
b) wherein said at least one magnetizable sheet provides a favorable balance of stiffness and flexibility for enhancing the handling of said at least one magnetizable sheet with commercial printers, cutting tools, and processing equipment required for the manufacture of said at least one magnetizable sheet.

28. A coating composition, relating to providing printable coatings for flexible magnetic sheets, comprising:
a) Ethylene Vinyl Acetate
b) Titanium Dioxide; and
c) at least one chemical surfactant.
d) wherein said Ethylene Vinyl Acetate comprises a majority component by weight of such composition.
